(19) United States
(12) Patent Application Publication
(10) Pub. No.: US 2003/0226507 A1
(43) Pub. Date: Dec. 11, 2003

(54) A METHOD OF AND A DEVICE FOR MILKING ANIMALS

(75) Inventor: Antoon Peter Andre THEELEN, Maassluis (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, Zug (CH)

(21) Appl. No.: 10/249,977

(22) Filed: May 23, 2003

(30) Foreign Application Priority Data
Jun. 6, 2002 (NL) 1020788

(51) Int. Cl. A01J 3/00

(52) U.S. Cl. 119/14.2

(57) ABSTRACT

A method of and a device for automatically milking one animal selected from a group of animals, a milking criterion being established for a milking-related action, and a desired cumulative amount of milk to be produced by the group of animals being established. The milking criterion is adapted with the aid of the cumulative amount produced and the cumulative amount desired.

### CROSS REFERENCE TO RELATED APPLICATIONS

This application claims priority from Dutch patent application number 1020788, filed Jun. 6, 2002, the contents of which are hereby incorporated by reference in their entirety.

### BACKGROUND OF INVENTION

1. Field of the Invention

The invention relates to methods of milking dairy animals and more particularly to methods of automatically milking dairy animals to meet specific production criteria.

2. Description of the Related Art

Methods and devices are known for automatically milking one animal out of a group of animals by means of a milking robot. In such methods, a cow is allowed to move freely in an area and individually visit, from said area, a milking stall to be milked. The milking robot is located in the milking stall. Prior to being milked, the animal is identified by means of an identification system. The computer of the milking robot decides, on the basis of a milking criterion, whether or not the animal is allowed to be milked. The animal is milked if, since the previous milking, at least a specific number of milkings of other animals has taken place. Said specific number of milkings is a function of parameters that may relate both to the group of animals, such as the total number of milkings per unit of time, and to the individual animal to be milked, such as the individual milking figure. The individual milking figure comprises the average number of milkings desired per unit of time and may depend on a number of parameters, such as the animal's health and lactation stage. In this manner, it is achieved that the production and the production capacity of the device are properly attuned to each other. U.S. Pat. No. 6,209,485, the contents of which are hereby incorporated by reference in their entirety, discloses a method of this type.

In the current practice of cattle farming, skilful planning of the production of a group of animals is very important. Said production is frequently determined by external factors such as quota regulations. The quota regulations determine that only a particular maximum production, the so-called quota, is permitted during a fixed period, the so-called quota-year. Both producing less and producing more than a particular planned production may become a very expensive affair because of such regulations. However, the methods and devices mentioned above do not indicate how to achieve said particular production.

### SUMMARY OF INVENTION

The invention aims at providing a method of the above-mentioned type, by means of which better planning of the production of an animal or a group of animals is possible.

According to the invention, for this purpose a method of automatically milking an animal selected from a group of animals is disclosed. The method comprises the steps of: establishing a milking criterion including the conditions of a milking-related action and the way in which said milking-related action is performed; establishing a desired cumulative amount of milk or milk component to be produced by the group of animals from a predetermined first quota-related point of time to a predetermined future second quota-related point of time; determining the cumulative amount of milk or milk component produced by the group of animals from an initial point of time; and adapting the milking criterion with the aid of the cumulative amount of milk or milk component produced and with the aid of the amount desired. By means of this method, the amount of milk or milk component still to be produced by the whole group can be taken into account. This is done by choosing the milking criterion in such a way that the milking is automatically adapted and that the planned target, i.e. a particular cumulative production, can be attained at least partially. The milking criterion may include the condition of a milking-related action and the way in which said milking-related action is performed at milking. A change of the conditions and/or the way in which the action takes place may have an immediate effect on the results of the milking process, such as the milk output and the composition of the milk. Details of such milking and animal related actions which may be used as milking criteria are disclosed in copending U.S. patent application Ser. No. 10/248,647 entitled “A method and device for performing a milking procedure on a dairy animal” the contents of which are hereby incorporated by reference in their entirety.

Further details of how milking parameters and variables may be used to separate milk from particular dairy animals may also be found in copending U.S. patent application Ser. No. 10/255,174 entitled “A Device and Method for Separating Milk from Dairy Animals”, and Ser. No. 10/255,173 entitled “A Device and Method for Separating Milk from a Dairy Animal” the contents of which are hereby incorporated by reference in their entirety.

In a particular embodiment of the method, the initial point of time is the first quota-related point of time. In this manner, the period of the desired production entirely corresponds to the period in which production will take place, so that over the period preceding the initial point of time no artificial calculation of production data is required.

In a further embodiment of the method, the method further comprises the step of determining the momentary point of time, and the step of adapting the milking criterion with the aid of the momentary point of time.

In this way, it is possible to take into account how far the momentary point of time of production is away from the second quota-related point of time, usually the end of a quota-year period. If said momentary point of time is relatively far away from the second quota-related point of time, a number of external production conditions, such as the weather, may cause too much uncertainty in the production, so that a production change caused by the milking criterion will fall within said uncertainty.

In another embodiment according to the invention, the method further comprises the step of determining the time elapsed since the first quota-related point of time, and the step of adapting the milking criterion with the aid of the time elapsed.

It is advantageous if the method further comprises the step of determining the production quotient i.e. the ratio between the cumulative amount and the time elapsed, the step of determining the quota quotient i.e. the ratio between the cumulative amount desired and the difference between the first and the second quota-related point of time, and the step of adapting the milking criterion with the aid of the production quotient and the quota quotient.

By adapting the milking criterion in such a way that the momentary production quotient is equal to the quota quotient, the cumulative production desired will correspond to the cumulative production produced.

In an advantageous embodiment according to the invention, the method further comprises the step of collecting historical production data, and the step of performing a mathematical operation on the historical production data in order to forecast at least part of the production pattern in the period until the second quota-related point of time, and the step of adapting the milking criterion with the aid of the forecast production pattern.

There are known mathematical operations, such as formulas, that are able to determine the future production on the basis of known production data of an animal and for example the lactation stage of the animal. By performing the method for each animal out of the group of animals, it is possible to forecast the total future production pattern until the second quota-related point of time.

In a further embodiment according to the invention, the method further comprises the step of determining the historical pattern of the production of a given group of animals during a period in the past, which period corresponds to the period from the initial point of time to the second quota-related point of time, the step of determining the recent production pattern of the group of animals comprising the production during the period from the initial point of time, and the step of determining the forecast production pattern by comparing the recent pattern with the historical pattern.

Production data from a year ago are nearly always known. If the quota of that year is equal to the desired production, and assuming that the production passes through an annual cycle, it is possible to forecast the coming production pattern by extrapolation of the recent pattern with the pattern of a year ago.

In an advantageous embodiment of the method according to the invention, the milking criterion includes the possibility of clearance of an animal for milking. It is known that, if an animal is milked less frequently, it will have a lower total production, both as to the total amount of fat and the total amount of milk. The milking criterion including the number of milkings per day should be decreased if the desired production threatens to be exceeded. If the quota is based on the total fat production, the so-called fat quota, it is advantageous to apply said measure to animals producing milk with a high fat content. If a high protein production is desired, it may be advantageous to adapt the milking criterion in the described manner only with animals having a high fat/protein ratio, so that animals having a relatively high protein production will not be milked less frequently.

In an advantageous embodiment of the method according to the invention, the method further comprises the step of disconnecting teat cups connected to the udder of the animal, and the milking criterion includes parameters regarding the disconnection. It is known that the milk that is drawn at the end of milking has a much higher fat content than the milk that has been drawn earlier. If the fat quota threatens to be exceeded, the parameters regarding the disconnection may be chosen in such a way that the teat cups are disconnected earlier. Due to this, the fat milk will remain in the animal and the average fat content of the drawn milk will fall.

In another embodiment, the method further comprises the step of pre-stimulation, and the milking criterion includes parameters regarding the pre-stimulation.

In a particular embodiment, the method further comprises the step of foremilking the animal, and the milking criterion includes parameters regarding the foremilking. The so-called foremilk, the first part of the drawn milk, has a lower quality and is consequently mostly separated by means of a separate foremilking device. If the quota is in danger of not being achieved, it is advantageous to adapt the milking criterion in such a way that a smaller amount of foremilk, or even no foremilk, is separated.

In another embodiment according to the invention, the method further comprises the step of separating at least part of the amount of milk to be drawn in one milking run of the animal, and the milking criterion includes parameters regarding the separation. If the quota threatens to be exceeded, the milking criterion may be adjusted in such a way that milk from certain animals is separated and does not have to be included in the total production. This is particularly advantageous with a fat quota if milk from animals producing milk with a fat content higher than the average fat content is separated.

As a consequence, the average fat content of the cumulatively produced milk will fall.

In a particular embodiment according to the invention, the part to be separated concerns the last part of an amount of milk to be drawn in the milking run. By the end of a milking the fat content rises considerably, to as much as approximately 10%. Therefore, if the fat quota threatens to be exceeded, it is advantageous to separate the last part. Although it is also possible not to draw the last part of the milk, especially with larger amounts, this is not beneficial to the animals” udder health.

In an advantageous embodiment of the method, the parameters can be adjusted per udder quarter. The quarters of an udder may differ considerably in terms of capacity, milk output speed, composition of the milk, etc. In particular, the front part of the udder (front quarters) may differ considerably from the rear part (rear quarters). Moreover, differences may occur due to the fact that a quarter shows an infection. Therefore, for a good performance of the method, it is necessary to consider each quarter individually.

It is advantageous if the milking-related action comprises the supply of feed and if the milking criterion includes parameters regarding the amount and type of feed. It is a known option to control the amount of milk to be produced by an animal and the contents thereof by means of feeding. By combining the supply of feed with automatically milking an animal, effective utilization of the active time of the animal is achieved.

It is further advantageous if the milking criterion can individually be adapted per animal. In this manner, the method can optimally be adapted per animal.

In a further advantageous embodiment according to the invention, the method comprises: the step of forecasting the effect of applying the invention to the production of the animal on the basis of individual production data of the animal, the step of comparing the effect with a predetermined desired effect, and the step of applying the invention if the forecast effect is greater than the desired effect. Applying the method may also have undesired effects. It often raises the risk of health problems. In that case a raised health risk and a positive effect on the desired production should be weighed against each other.

According to a further aspect of the invention, there is also provided a device for milking an animal selected from a group of animals, the device comprising at least one teat cup to be attached to a teat of an animal to be milked; an actuation device for performing at least one milking-related action on the animal; and a controller for controlling the actuation device to perform quota dependent milking according to the above-mentioned methods. The actuation device may perform any of the animal-related actions associated with milking including stimulation, foremilking, pre-cleaning, main milking, teat-cup attachment, teat-cup removal etc.

In a particular embodiment of the device according to the invention there may be provided a switching device making it possible to apply or not to apply the method. By means of said switching device it is possible at all times to perform in a simple manner the automatic milking in the standard way.

### BRIEF DESCRIPTION OF DRAWINGS

An embodiment of the invention will be explained hereinafter in detail by way of example only with reference to the accompanying figures, in which:

FIG. 1 is a side view of a possible device according to the invention;

FIG. 2 is a graph of the pattern of a daily production;

FIG. 3 is a graph of the pattern of the cumulative production from point of time T1, on the basis of the daily production of FIG. 2.

### DETAILED DESCRIPTION

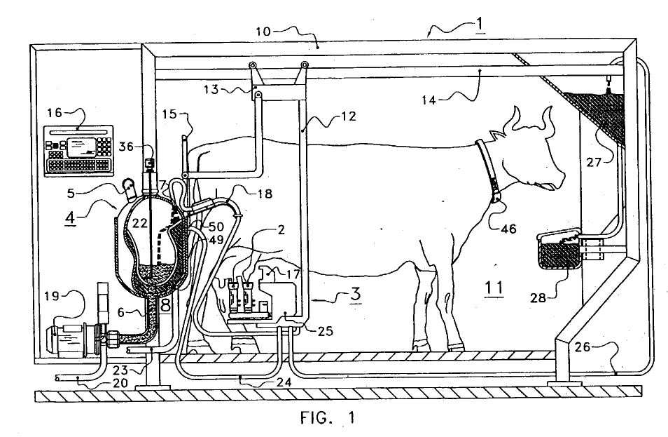

FIG. 1 is a side view of a possible device according to the invention in the form of a milking stall, in which a cow to be milked is present. Such a milking stall may be of the type described in U.S. Pat. No. 6,213,051 the contents of which are hereby incorporated by reference in their entirety. The basis of the device is constituted by a frame 1. There are provided an entrance gate,2 and an exit gate 3 for allowing an animal to enter respectively to leave the animal area 4 of the device. There is disposed a feed trough 5 for supplying two types of feed, for example a high-energy feed and a high-protein feed. A feed-metering device 6 meters the two types of feed in the feed trough 5. By supplying the two types of feed in a particular ratio it is possible to address the specific needs of an animal. The milking device 7 with four teat cups 8 is fastened to a robot arm 9. The robot arm 9 moves the device 7 under the animal. Connection and disconnection of the teat cups 8 to the teats of the animal takes place automatically. Inside the milking device 7 there are provided flow sensors for measuring the flow of the milk drawn per udder quarter. The first part of the drawn milk, the foremilk, is discharged via a discharge tube 10 to the sewer 11. For this purpose, each milk line coming from a teat cup is provided with a sewer valve for guiding the milk optionally to the collecting vessel 12 or to the discharge tube 10. Said valves are controlled on the basis of the values from the flow sensors. The milk from a milking that is not discharged to the sewer is collected in the collecting vessel 12. Via a pump 14 and a three-way valve 13 the milk from the collecting vessel 12 can optionally be guided to a milk-cooling tank (not shown) or to a separation tank 15. An animal-identification device is provided for identification of an animal reporting at the device. The animal identification device co-operates with a transponder that an animal wears around its neck. A computer 16 ensures the control of the various components and ensures data-processing.

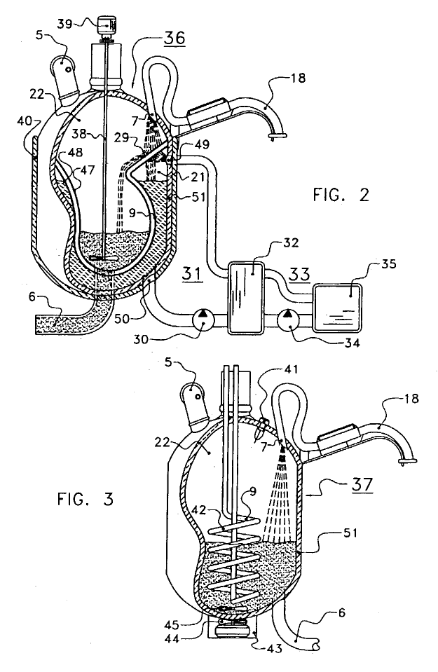

The device operates as follows: First of all the computer 16 determines whether the milking criterion should be adapted. For this purpose, from data stored in the memory of the computer 16, the pattern of the production, in this case expressed in kg fat, of the previous quota year is determined, indicated by line A in FIG. 2. Said production is compared with the recent production pattern B1 until the momentary point of time T. Î□P indicates the difference at point of time T between line B1 and A. By superimposing Î□P on the pattern of the previous year A, the forecast production pattern B2 until T2 is determined. Line G indicates the pattern of the constant production by means of which at point of time T2 the desired production Q is achieved.

FIG. 3 shows the cumulative production pattern B1c from the first quota-related point of time T1. Said figure can easily be produced from FIG. 2 by summation of the daily productions from point of time T1. It can be seen that the expected cumulative production at point of time T2, indicated by P, is higher than the desired cumulative production Q at T2. In order to make a correction, the milking criterion should be adapted in such a way that the forecast production P will come more in the vicinity of Q and preferably coincides with Q. Line Gc indicates the pattern of the cumulative production to obtain the desired production Q.

When an animal reports at the device it is recognized by the animal identification device. Subsequently the computer 16 determines whether the period of time since the last milking, the milking interval, has exceeded a minimum value established for the animal, the so-called milking criterion. Because of the imminent exceeding of the fat quota, the computer 16 has set the minimum milking interval higher than the standard value. By means of the following numerical example the determination of the new milking criterion can be illustrated, only said milking criterion being adapted.

Suppose the desired cumulative annual production (Q) is 520,000 kg. At the momentary point of time (T) the cumulative production is 482,400 kg. If this is extrapolated linearly, at an unchanged daily production, there will be obtained a forecast annual production (P) of 482,400/48×52=522,600 kg at point of time T2, i.e. an over-production of 0.5%. This corresponds to a desired production decrease in the remaining four weeks of 2600/(4/52×522,600)×100%=6.5%. It is known that, by milking with a milking robot, it is possible to achieve a higher daily production in comparison with conventionally milking two times a day. This is caused by a higher number of milkings per day. Table 1 illustrates the effect of the number of milkings per day and consequently the milking interval (MI) on the daily production relative to milking two times a day.

Table 1 Suppose the average MI amounts to 8.0 h (3.0 milkings per day), then a decrease of 6.5% is obtained by reducing the number of milkings to 2.2, which corresponds to an increase of the MI to 10.9 h. The computer has such a table in its memory and calculates the new desired MI. The minimum MI, i.e. the milking criterion, is equated herewith. In another embodiment, the individual minimum MI is increased by 2.9 h for each animal, so that the differences in MI between the individual animals are maintained.

If the minimum milking interval has been exceeded, the animal is admitted. The metering device 6 meters the desired feed and the robot arm 9 connects the milking device 7. Because of the imminent exceeding of the fat quota, less feed is now supplied. As a result thereof, the expected future milk production will fall. At the beginning of the milking the sewer valves are set in such a way that the foremilk is passed via the discharge tube 10 to the sewer 11. Because of the imminent exceeding of the fat quota, the same applies to the last part of the drawn milk. After disconnection of the milking device 7 by the robot arm 9 and disinfection of the teats, the exit gate 3 is opened and the animal is allowed to leave the device. From data in the memory of the computer coming from a previous external milk analysis or coming from the measurement data obtained by means of sensors in the milking device, the fat content of the milk obtained is determined. If the milk from the animal has such a high fat content that a particular value of the milking criterion related thereto is exceeded, the computer 16 may decide to adjust the three-way valve 13 in such a way that it is positioned in the direction of the separation vessel 15. The pump 14 subsequently empties the collecting vessel 12 into the separation vessel 15.

Many modifications in addition to those described above may be made to the structures and techniques described herein without departing from the spirit and scope of the invention. Accordingly, although specific embodiments have been described, these are examples only and are not limiting upon the scope of the invention.

1. A method of automatically milking an animal selected from a group of animals, the method comprising:
establishing a milking criterion defining the conditions for performing a milking-related action;
establishing a desired cumulative amount of milk or milk component to be produced by the group of animals from a predetermined first quota-related point of time to a predetermined future second quota-related point of time, determining the cumulative amount of milk or milk component produced by the group of animals from an initial point of time; and
adapting the milking criterion with the aid of the cumulative amount of milk or milk component produced and with the aid of the desired cumulative amount of milk or milk component.

2. The method as claimed in claim 1, wherein the initial point of time is the first quota-related point of time.

3. The method as claimed in claim 1, wherein the method further comprises:
determining a momentary point of time; and
adapting the milking criterion with the aid of the momentary point of time.

4. The method as claimed in claim 3, wherein the method further comprises:
determining a time elapsed since the first quota-related point of time; and
adapting the milking criterion with the aid of the time elapsed.

5. The method as claimed in claim 4, wherein the method further comprises:
determining a production quotient defined by a ratio between the cumulative amount of milk or milk component produced and the time elapsed;
determining a quota quotient defined by a ratio between the cumulative amount desired and the difference between the first and the second quota-related point of time; and
adapting the milking criterion with the aid of the production quotient and the quota quotient.

6. The method as claimed in claim 1, wherein the method further comprises:
collecting historical production data;
performing a mathematical operation on the historical production data in order to forecast at least a part of the production pattern in the period until the second quota-related point of time; and
adapting the milking criterion with the aid of the forecast production pattern.

7. The method as claimed in claim 6, wherein the method further comprises:
determining a historical pattern of production of the group of animals during a period in the past, which period corresponds to a period from the initial point of time to the second quota-related point of time;
determining a recent production pattern of the group of animals comprising production during a period from the initial point of time; and
determining a forecast production pattern by comparing the recent production pattern with the historical pattern.

8. The method as claimed in claim 1, wherein the milking criterion defines whether an animal is allowed to be milked.

9. The method as claimed in claim 1, wherein the method further comprises disconnecting teat cups connected to an udder of the animal and wherein the milking criterion defines parameters relating to disconnection of the teacups.

10. The method as claimed in claim 9, wherein the parameters can be adjusted per udder quarter.

11. The method as claimed in claim 1, wherein the method further comprises the step of foremilking the animal and wherein the milking criterion defines parameters regarding foremilking.

12. The method as claimed in claim 11, wherein the parameters can be adjusted per udder quarter.

13. The method as claimed in claim 1, wherein the method further comprises pre-stimulation and wherein the milking criterion includes parameters regarding pre-stimulation.

14. The method as claimed in claim 13, wherein the parameters can be adjusted per udder quarter.

15. The method as claimed in claim 1, wherein the method further comprises separating a part of an amount of milk to be drawn in one milking run of the animal and wherein the milking criterion defines parameters regarding separation.

16. The method as claimed in claim 15, wherein the parameters can be adjusted per udder quarter.

17. The method as claimed in claim 15, wherein the part to be separated concerns a last part of an amount of milk to be drawn in the milking run.

18. The method as claimed in claim 1, wherein the milking-related action comprises the supply of feed arid the milking criterion defines parameters regarding the amount and type of feed.

19. The method as claimed in claim 1, wherein the milking criterion can individually be adapted per animal.

20. A method for automatically milking one animal out of a group of animals, wherein the method comprises:
forecasting the effect of applying the method as claimed in claim 1 to milk production of the animal on the basis of individual production data of the animal;
comparing the effect with a predetermined desired effect; and
applying the method as claimed in claim 1, if the forecast effect is greater than the desired effect.

21. A device for milking an animal selected from a group of animals, the device comprising:
at least one teat cup to be attached to a teat of an animal to be milked;
an actuation device for performing at least one milking-related action on the animal; and
a controller for controlling the actuation device to perform quota dependent milking, the controller being provided with a milking criterion defining the conditions for performing the milking-related action, the controller being capable of:
establishing a desired cumulative amount of milk or milk component to be produced by the group of animals from a predetermined first quota-related point of time to a predetermined future second quota-related point of time, determining the cumulative amount of milk or milk component produced by the group of animals from an initial point of time; and
adapting the milking criterion with the aid of the cumulative amount of milk or milk component produced and with the aid of the desired cumulative amount of milk or milk component.

22. The device as claimed in claim 21, wherein the controller further comprises a switch for selectively controlling the actuation device to perform quota dependent milking.
